(19) United States
(12) Patent Application Publication
(10) Pub. No.: US 2023/0289667 A1
(43) Pub. Date: Sep. 14, 2023

(54) CONTEXTUAL RELEVANCE FOR SHARED MOBILITY

(71) Applicant: HERE GLOBAL B.V., Eindhoven (NL)

(72) Inventor: Jerome BEAUREPAIRE, Berlin (DE)

(21) Appl. No.: 17/689,183

(22) Filed: Mar. 8, 2022

(51) Int. Cl. G06Q 10/02; G01C 21/34

(52) U.S. Cl. CPC G06Q 10/02; G01C 21/3438

(57) ABSTRACT

A method, apparatus and computer program product are provided to dynamically determine and convey contextual relevance measures for shared vehicles. In one embodiment, a method is provided. The method includes identifying a user seeking transportation to a destination and identifying shared vehicles configured for transporting the user. The method further includes obtaining environmental context data based at least in part on a geographic area within which the user and the destination are located. The method further includes generating a contextual relevance measure for each shared vehicle. The contextual relevance measure is generated according to at least one of the environmental context data, configuration data for the one or more shared vehicles, or profile data associated with the user. The method further includes, responsive to determining that the contextual relevance measure for a particular shared vehicle satisfies a configurable threshold, causing a physical configuration change for the particular shared vehicle

### TECHNOLOGICAL FIELD

An example embodiment relates generally to a method, apparatus and computer program product for management and use of shared vehicles, shared-use transportation, autonomous vehicles, courier-type and/or shuttle vehicles, and/or the like.

### BACKGROUND

Shared vehicles (SVs) provide one of a number of available transportation modes for a user to travel to a destination. However, in various examples, it may not be clear to a user whether transportation via an SV would be more advantageous, reliable, and/or efficient compared to another transportation mode at a given moment in time or for a given situation. For instance, some users may habitually rely upon public transportation modes despite SV-based transportation being more reliable in certain scenarios, such as during a delay of a public train. Further, with respect to selection of an SV for transportation of a user, suitability of one particular SV over another SV may be obfuscated or at least non-obvious to the user. Accordingly, various challenges relate to contextual relevance of SVs and to context-awareness between SVs and with other transportation modes in various examples.

### BRIEF SUMMARY

In general, embodiments of the present disclosure provide methods, apparatuses, computer program products, systems, devices, and/or the like for generating contextual relevance measures for shared vehicles (SVs) and indicating relevance of SVs to a user. Specifically, in various embodiments, data relevant to a context of an SV, the user, and/or the user's destination is collected and used to generate a contextual relevance measure for each of one or more SVs configured for transporting the user. In various embodiments, SVs having significant and/or satisfactory contextual relevance measures—thereby suggesting that the SVs are relevant to a user and/or for a given situation—may undergo a physical configuration change in order to convey their relevance to the user. For example, relevant SVs may be configured to flash or otherwise operate their illuminating hardware (e.g., LEDs, headlights, and/or the like), and in various example embodiments, relevant SVs may autonomously navigate into a line-of-sight of the user. Accordingly, various embodiments provide technical advantages and effects through determining and conveying relevance of SVs to users, thereby enabling efficient transportation of users, improving transportation throughput, and reducing infrastructure load, in various examples.

According to an aspect of the present disclosure, an apparatus including at least processing circuitry and at least one non-transitory memory including computer program code instructions is provided. In one embodiment, the computer program code instructions are configured to, when executed by the processing circuitry, cause the apparatus to identify a user seeking transportation to a destination and one or more shared vehicles configured for transporting the user. The computer program code instructions are further configured to, when executed by the processing circuitry, cause the apparatus to obtain environmental context data based at least in part on a geographic area within which the user and the destination are located. The computer program code instructions are further configured to, when executed by the processing circuitry, cause the apparatus to generate a contextual relevance measure for each shared vehicle of the one or more shared vehicles with respect to the user and the destination. The contextual relevance measure is generated according to at least one of the environmental context data, configuration data for the one or more shared vehicles, or profile data associated with the user. The computer program code instructions are further configured to, when executed by the processing circuitry, cause the apparatus to, responsive to determining that the contextual relevance measure for a particular shared vehicle of the one or more shared vehicle satisfies a configurable threshold, cause a physical configuration change for the particular shared vehicle.

In various embodiments, the contextual relevance measure for each shared vehicle is dynamically generated over time, and the physical configuration change is caused for a given time period. For example, the contextual relevance measure for a shared vehicle is generated at a configurable frequency, and a physical configuration change for the shared vehicle may be caused for a time period before the contextual relevance measure is re-generated or re-evaluated.

In various embodiments, the environmental context data includes scheduling data of one or more alternative transportation modes. In various embodiments, the one or more alternative transportation modes comprises a public transportation mode historically used by the user according to the profile data associated with the user. In various embodiments, the environmental context data is obtained from one or more environmental systems via an application programming interface (API).

In various embodiments, the computer program code instructions are configured to, when executed by the processing circuitry, cause the apparatus to cause a physical configuration change for the particular shared vehicle by determining whether the particular shared vehicle at an initial position is within a direct line-of-sight of the user, and upon determination that the particular shared vehicle at the initial position is not within the direct line-of-sight of the user, causing movement of the particular shared vehicle to a visible position determined to be within the direct line-of-sight of the user. In various embodiments, the computer program code instructions are configured to, when executed by the processing circuitry, cause the apparatus to cause a physical configuration change for the particular shared vehicle by operating illuminating hardware of the particular shared vehicle. In various embodiments, the physical configuration change for the particular shared vehicle is caused remotely via network communication.

In various embodiments, the contextual relevance measure is generated via a weighted combination of the environmental context data, the configuration data for the plurality of shared vehicles, and the profile data associated with the user. In various embodiments, a relevance model may be used to generate the contextual relevance measure with the environmental context data, the configuration data, and the profile data being inputs to the relevance model. For example, the relevance model is a trained machine learning model.

According to another aspect of the present disclosure, a computer program product including at least one non-transitory computer-readable storage medium having computer-executable program code instructions stored therein is provided. In one embodiment, the computer-executable program code instructions include program code instructions to identify a user seeking transportation to a destination and one or more shared vehicles configured for transporting the user. The computer-executable program code instructions further include program code instructions to obtain environmental context data based at least in part on a geographic area within which the user and the destination are located. The computer-executable program code instructions further include program code instructions to generate a contextual relevance measure for each shared vehicle of the one or more shared vehicles with respect to the user and the destination. The contextual relevance measure is generated according to at least one of the environmental context data, configuration data for the one or more shared vehicles, or profile data associated with the user. The computer-executable program code instructions further include program code instructions to, responsive to determining that the contextual relevance measure for a particular shared vehicle of the one or more shared vehicle satisfies a configurable threshold, cause a physical configuration change for the particular shared vehicle.

In various embodiments, the contextual relevance measure for each shared vehicle is dynamically generated over time, and the physical configuration change is caused for a given time period. For example, the contextual relevance measure for a shared vehicle is generated at a configurable frequency, and a physical configuration change for the shared vehicle may be caused for a time period before the contextual relevance measure is re-generated or re-evaluated.

In various embodiments, the environmental context data includes scheduling data of one or more alternative transportation modes. In various embodiments, the one or more alternative transportation modes comprises a public transportation mode historically used by the user according to the profile data associated with the user. In various embodiments, the environmental context data is obtained from one or more environmental systems via an application programming interface (API).

In various embodiments, the program code instructions for causing a physical configuration change for the particular shared vehicle include program code instructions for determining whether the particular shared vehicle at an initial position is within a direct line-of-sight of the user, and upon determination that the particular shared vehicle at the initial position is not within the direct line-of-sight of the user, causing movement of the particular shared vehicle to a visible position determined to be within the direct line-of-sight of the user. In various embodiments, the program code instructions for causing a physical configuration change for the particular shared vehicle include program code instructions for operating illuminating hardware of the particular shared vehicle. In various embodiments, the physical configuration change for the particular shared vehicle is caused remotely via network communication.

In various embodiments, the contextual relevance measure is generated via a weighted combination of the environmental context data, the configuration data for the plurality of shared vehicles, and the profile data associated with the user. In various embodiments, a relevance model may be used to generate the contextual relevance measure with the environmental context data, the configuration data, and the profile data being inputs to the relevance model. For example, the relevance model is a trained machine learning model.

According to yet another aspect of the present disclosure, a method is provided, the method including identifying a user seeking transportation to a destination and one or more shared vehicles configured for transporting the user. The method further includes obtaining environmental context data based at least in part on a geographic area within which the user and the destination are located. The method further includes generating a contextual relevance measure for each shared vehicle of the one or more shared vehicles with respect to the user and the destination. The contextual relevance measure is generated according to at least one of the environmental context data, configuration data for the one or more shared vehicles, or profile data associated with the user. The method further includes causing, responsive to determining that the contextual relevance measure for a particular shared vehicle of the one or more shared vehicle satisfies a configurable threshold, a physical configuration change for the particular shared vehicle.

In various embodiments, the contextual relevance measure for each shared vehicle is dynamically generated over time, and the physical configuration change is caused for a given time period. For example, the contextual relevance measure for a shared vehicle is generated at a configurable frequency, and a physical configuration change for the shared vehicle may be caused for a time period before the contextual relevance measure is re-generated or re-evaluated.

In various embodiments, the environmental context data includes scheduling data of one or more alternative transportation modes. In various embodiments, the one or more alternative transportation modes comprises a public transportation mode historically used by the user according to the profile data associated with the user. In various embodiments, the environmental context data is obtained from one or more environmental systems via an application programming interface (API).

In various embodiments, causing a physical configuration change for the particular shared vehicle includes determining whether the particular shared vehicle at an initial position is within a direct line-of-sight of the user, and upon determination that the particular shared vehicle at the initial position is not within the direct line-of-sight of the user, causing movement of the particular shared vehicle to a visible position determined to be within the direct line-of-sight of the user. In various embodiments, causing a physical configuration change for the particular shared vehicle includes operating illuminating hardware of the particular shared vehicle. In various embodiments, the physical configuration change for the particular shared vehicle is caused remotely via network communication.

In various embodiments, the contextual relevance measure is generated via a weighted combination of the environmental context data, the configuration data for the plurality of shared vehicles, and the profile data associated with the user. In various embodiments, a relevance model may be used to generate the contextual relevance measure with the environmental context data, the configuration data, and the profile data being inputs to the relevance model. For example, the relevance model is a trained machine learning model.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject matter will become apparent from the description, the drawings, and the claims

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 provides a diagram depicting an example system architecture in which a contextual relevance of a shared vehicle (SV) can be determined and conveyed to a user, in accordance with various example embodiments described herein;

FIG. 2 provides a block diagram illustrating an example apparatus that may be configured to determine and convey contextual relevance of SVs to a user, in accordance with various example embodiments described herein;

FIG. 3A provides a flowchart illustrating example operations performed to generate contextual relevance measures for SVs and to indicate contextually-relevant SVs according to their contextual relevance measures to a user, in accordance with various example embodiments described herein;

FIG. 3B provides a flowchart illustrating example operations performed to generate contextual relevance measures for SVs and to indicate contextually-relevant SVs according to their contextual relevance measures to a user, in accordance with various example embodiments described herein;

FIG. 4 provides a diagram depicting generation of an example contextual relevance measure for an SV, in accordance with various example embodiments described herein;

FIG. 5 depicts an example physical configuration change to indicate contextual relevance of an SV to a user, in accordance with various example embodiments described herein;

FIG. 6 provides a diagram illustrating an example physical configuration change to indicate contextual relevance of an SV to a user, in accordance with various example embodiments described herein; and

FIG. 7 illustrates an example user interface through which contextually-relevant SVs may be indicated to a user, in accordance with various example embodiments described herein.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Numerous modes of transportation ranging from private vehicular transportation to public transportation are available to users for transportation to a destination. Shared vehicles constitute one such transportation mode configured to transport users to a destination, and shared vehicles occupy a middle ground between private vehicle use and public transportation use. Generally, use of a shared vehicle (SV) is shared between (e.g., rented by) multiple users that may be traveling to different destinations, and SV usage may include users simultaneously sharing an SV (e.g., ride-sharing, hitch-hiking) and/or users sequentially or separately using an SV and each depositing the SV in a public area when transportation is complete. In some examples, an SV may not be wholly owned by a user or exclusive to one user. Examples of SV-based transportation, or shared mobility generally, may include but are not limited to bike-sharing, scooter-sharing, car-sharing (e.g., autonomously driven, semi-autonomously driven, non-autonomously driven), on-demand ride services and e-hail services, ride-sharing and ride-splitting, and/or the like. Various embodiments described herein may generally be applied to promote usage of SV use, SV-based transportation, shared mobility, and/or similar terms used herein interchangeably in at least the above-identified shared mobility examples.

In particular, various embodiments described herein may be directed to promoting SV usage when shared mobility is contextually relevant. SVs may be particularly relevant for user transportation at certain points in time; for instance, a shared vehicle or shared mobility generally may be available, advantageous, reliable, efficient, and/or the like for transporting a user to a destination at certain points in time. Contextual relevance may specifically refer to SV-based transportation being more available, more advantageous, more reliable, more efficient, and/or the like for user transportation compared to other modes of transportation at certain points in time, in various examples.

Accordingly, SV contextual relevance may be dynamic over time, and SVs can increase and/or decrease in contextual relevancy in certain contexts, after certain events, during certain scenarios, and/or the like. For example, SVs may be a more contextually relevant transportation mode when alternative transportation modes (e.g., public transportation, private vehicles) are delayed, unavailable, inefficient, near or at maximum capacity, and/or the like.

Generally, such contexts, events, scenarios, and/or the like may not be readily apparent to a user seeking transportation to a destination, and as a result, the user may not be aware of the resulting contextual relevance of SV-based transportation. Similarly, a user aware of such events and scenarios may not necessarily realize or associate the events and scenarios with increased relevance of SV-based transportation or shared mobility. Further, multiple shared vehicles may be available to the user, and it may not be readily apparent or recognizable whether particular SVs are more relevant or suitable compared to other SVs.

Therefore, various embodiments address technical challenges at least by measuring contextual relevance of SVs and conveying the contextual relevance of SVs to users. In particular, various embodiments described herein relate to generating a contextual relevance measure for each of a plurality of SVs, and particular SVs having a significant and/or satisfactory contextual relevance measures may be indicated to the user. In various embodiments, indication of SVs that are contextually relevant, or having a significant and/or satisfactory contextual relevance measure, may be provided via user equipment (e.g., a cell phone, a laptop, a personal computing device, a tablet) associated with the user. Indication of contextually relevant SVs may occur through physical configuration changes of the SVs, including light toggling, light flashing, movement (e.g., into a line-of-sight, in a recognizable or attention-attracting pattern), and/or the like. As such, in various embodiments, users are generally made aware of contextually relevant SVs.

In various embodiments, the contextual relevance measure for each SV is generated according to various factors, including factors relating to environmental context, factors relating to the user, factors relating to the SV itself, and/or the like. In particular, in some example embodiments, the factors may include public transportation scheduling data (e.g., train timetables, train delay notifications), weather forecasting data, profile and/or demographic data, SV configuration data (e.g., battery levels, range, operation zone, average speed, weight capacity), navigation data (e.g., routes to a specific destination), and/or the like. Thus, multiple dimensions and aspects of a given context may be considered in generating a contextual relevance measure for an SV, in various examples.

By generating contextual relevance measures for SVs and indicating contextually relevant SVs to a user, various embodiments provide technical advantages including at least improved efficiency in user transport. In one example involving a delay of a public train, a user may be made aware of SVs configured to transport the user to a destination, and the user may opt for SV-based transportation instead of waiting for the delayed train. In general, user awareness of SV contextual relevance enables users to reach their destinations efficiently and/or within a shorter timeframe. Improved efficiency of user transportation via shared mobility is associated with further technical effects and advantages, including reduction of public transportation infrastructure load. In another example involving a rush-hour or a high-density mass transit situation, SVs may be presented to some users as an alternative to a crowded public transport, thus reducing the load on public transportation and improving the operation thereof. That is, various embodiments described herein facilitate the efficient and intelligent distribution of users across different transportation modes.

Further yet, various embodiments may provide environmental benefits and effects through the promotion of shared vehicles such as bicycles, tricycles, and scooters. By encouraging usage of shared bicycles and shared scooters in relevant contexts in an advantageous manner, users may be diverted away from vehicular usage that is associated with carbon emissions. Certain shared vehicles are effectively used without requiring large quantities of energy and some (e.g., bicycles) can be used solely reliant upon a user's own energy contribution. Accordingly, various embodiments described herein enable and promote environmental benefits reaped through certain types of shared vehicles.

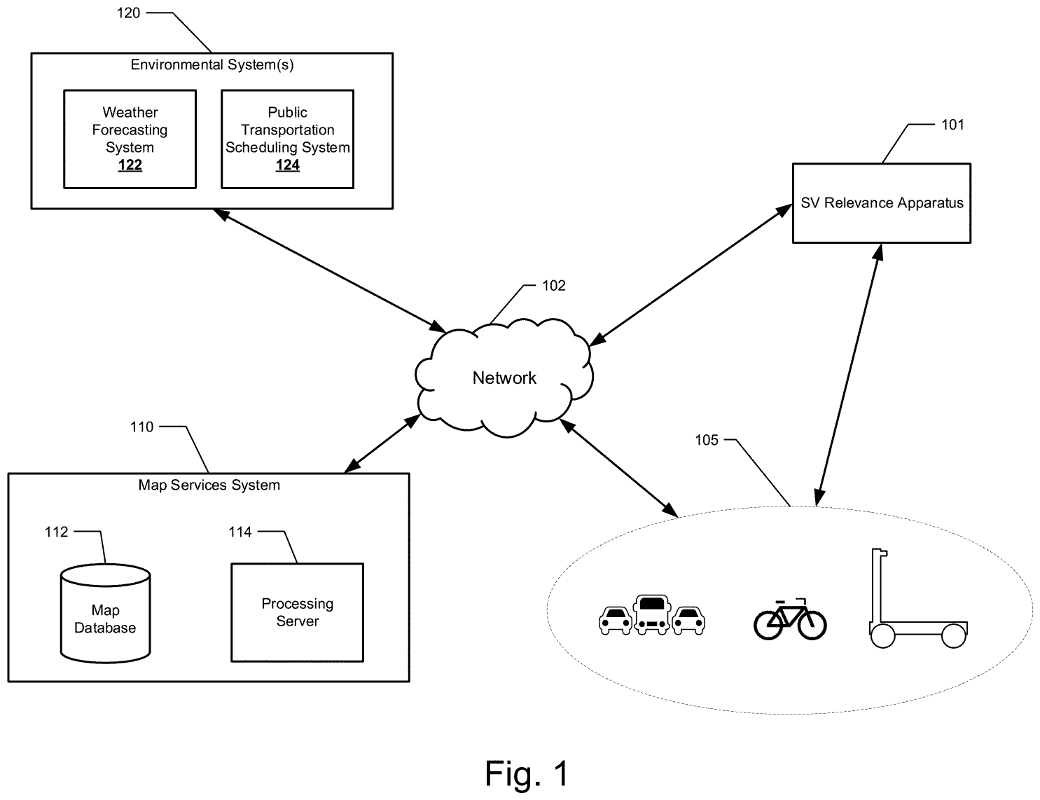

Referring now to FIG. 1, an exemplary system architecture in which certain example embodiments may operate is depicted. The exemplary system architecture may be configured at least for generating contextual relevance measures for a plurality of SVs and indicating (e.g., promoting, conveying) contextually relevant SVs to user based at least in part on the contextual relevance measures.

The illustrated embodiment of FIG. 1 includes an SV relevance apparatus 101 in data communication with a plurality of SVs 105, and the SV relevance apparatus 101 is configured to determine contextual relevance for one or more of the SVs 105. While FIG. 1 illustrates the plurality of SVs 105 including scooters, bikes, and cars, it will be understood that various embodiments may generally relate to any type of shared vehicle or shared mobility unit and are not necessarily limited to scooters, bikes, and cars, which are shown as illustrative examples.

In various embodiments, the SV relevance apparatus 101 is configured for performing operations relating to identifying users seeking transportations, obtaining data for ascertaining a context for the SVs 105 (e.g., environmental context data, user profile data, navigational data, and/or the like), generating contextual relevance measures for the SVs 105 using at least the obtained data, and causing contextually-relevant SVs to be indicated to the identified users. In one or more example embodiments, for example, the SV relevance apparatus 101 may be embodied by a central fleet management system for the plurality of SVs 105 configured to monitor the SVs 105, facilitate rental and booking of SVs 105 by users, manage user payments, unlock SVs 105 for usage, and/or the like. As such, a central fleet management system, in accordance with various embodiments described herein, may be further configured to generate contextual relevance measures for the SVs 105 and to indicate contextually relevant SVs 105 to users via communication to the users (e.g., through personal computing devices) and/or via remote control of the SVs 105.

In one or more other example embodiments, the SV relevance apparatus 101 may be embodied by a user equipment (UE) associated with a user that may be seeking transportation to a destination. In such embodiments, the UE may be configured to generate contextual relevance measures for the SVs 105, for example in response to a user query via a user interface of the UE. The UE may be configured to then specifically indicate contextually relevant SVs 105 to the user. In such embodiments, the UE may natively have access to profile data of the user and may exploit and/or particularly weight user-specific and/or personal data to determine SV contextual relevancies.

In one or more further example embodiments, the SV relevance apparatus 101 may be embodied by each individual SV of the SVs 105. For example, each SV 105 may be configured to generate their own respective contextual relevance measures and further to self-promote if their own respective contextual relevance measure is significant and/or satisfactory. In some examples, individual SVs may communicate via local network communication with other SVs to gather data used for the determination of contextual relevance. For example, in various embodiments, the SVs 105 may be configured to communicate with each other wireless communication, such as via sidelink communications in a 5^{th} Generation New Radio (5G) cellular network to share data, to communicate their own respective contextual relevance measures, to distribute computational operations relating to generating the contextual relevance measures, and/or the like.

In one or more further example embodiments, the SV relevance apparatus 101 may be embodied by one or more leader SVs of the SVs 105, with each leader SV having responsibility over a subset of the SVs 105. For example, a leader SV may lead and performing computing operations relevant for a unit, a convoy, a group, a cohort, and/or the like of SVs 105. The leader SV may be configured to generate contextual relevance measures for its constituent SVs and itself and may be further configured to cause relevant SVs out of the constituent SVs and itself to be indicated to a user. As discussed, in some examples, the leader SV may communicate with its constituent SVs via wireless communication, such as via sidelink communication in a 5G cellular network.

Thus, according to various embodiments, the SV relevance apparatus 101 (e.g., embodied by a centralized system, a UE or personal computing device, an individual SV, a leader SV) is configured to generate contextual relevance measures for SVs 105 and to indicate contextually-relevant SVs 105 to a user. In doing so, in some example embodiments, the SV relevance apparatus 101 may communicate with one or more SVs 105, with UEs, with various other systems, and/or the like via network communication via a network 102, for example, to obtain data for generating contextual relevance measures, to remotely control SVs 105, to push notifications to UEs, and/or the like. In various embodiments, the SV relevance apparatus 101 and other components of the system architecture illustrated in FIG. 1 communicate over one or more networks 102, which may include wired, wireless, or any combination of wired and wireless communication networks, such as cellular, Wi-Fi, internet, Bluetooth, local area networks, or the like. For example, the network 102 may be a cellular network (e.g., a 4^{th} generation Long Term Evolution cellular network, a 5G cellular network).

As shown in FIG. 1, the SV relevance apparatus 101 may communicate with a map services system 110, in various embodiments. Generally, the SV relevance apparatus 101 may be configured to communicate with the map services system 110 in order to determine locations of SVs 105 and users, determine and/or retrieve navigation routes and paths for a specific destination, identify geographical regions in the vicinity of the SVs 105 and users, map operation zones for SVs 105, and/or the like. Accordingly, data communicated between the SV relevance apparatus 101 and the map services system 110 may be used by the SV relevance apparatus 101 in order to generate a contextual relevance measure for an SV 105. In various embodiments, the map services system 110 may be configured to generate, maintain, update, and/or the like one or more digital maps based at least in part on probe data from probe apparatuses, mobility data from mobile devices (e.g., personal digital assistant (PDA), mobile telephone, smartphone, laptop computer, tablet computer, vehicle navigation system, infotainment system, in-vehicle computer, and/or the like), and/or the like.

In various embodiments, as illustrated, the map services system 110 may comprise a map database 112 and a processing server 114. The processing server 114 of the map services system 110 may also be embodied by a computing device and, in one embodiment, is embodied by a web server. The map database 112 may include one or more databases and may include information such as geographic information relating to road networks, points-of-interest, buildings, and/or the like. Further, the map database 112 may store therein historical dynamic population or mobility data, such as historical traffic data, mobile device data, monitored area data (e.g., closed-circuit television), and/or the like. Thus, the map database 112 may be used to facilitate the quantifying and measuring of human mobility within defined geographic regions and sub-regions to establish familiarity with a geographic region. Additionally, while FIG. 1 depicts a single map services system, various example embodiments may include any number of map services providers, any number of databases, and any number of processing servers, which may operate independently or collaborate to support activities of the embodiments described herein. Further, while FIG. 1 separately depicts the map services system 110 and the SV relevance apparatus 101, a single system may be used to embody at least the functionality of both the map services system 110 and the SV relevance apparatus 101. For example, in some example embodiments, the processing server 114 is configured to embody the SV relevance apparatus 101 and is configured to determine and convey contextual relevancies of the SVs 105.

The map data, such as the map data stored and managed by the map services system 110 (e.g., on the map database 112), may be maintained by a content provider such as a map developer. By way of example, the map developer can collect geographic data to generate and enhance the map database 112. There can be different methods used by the map developer to collect data. These methods can include obtaining data from other sources, such as municipalities or respective geographic authorities. In addition, the map developer can employ field personnel to travel by vehicle along roads throughout the geographic region to observe features and/or record information about them, for example, via probe data. Also, remote sensing, such as aerial or satellite photography, can be used to generate map geometries directly or through machine learning.

The map database 112 may include a master map database stored in a format that facilitates updating, maintenance, and development. For example, the master map database or data in the master map database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data may be compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by user equipment, for example. Further, data may be compiled defining segments of the map database.

The compilation to produce the end user database(s) can be performed by a party or entity separate from the map developer. For example, a navigation device developer or other end user device developer, can perform compilation on a received map database and/or probe database in a delivery format to produce one or more compiled databases. For example, as discussed herein, probe data may be map matched to segments defined in the map database.

As mentioned above, the map database 112 may include a master geographic database, but in certain embodiments, the map database 112 may represent a compiled navigation database that may be used in or with other systems and devices (e.g., SV relevance apparatus 101) to provide navigation and/or map-related functions. For example, the map database 112, or generally the map services system 110 via the processing server 114 in some examples, may provide navigation features to users via UEs, to SVs 105 (e.g., for SVs configured for autonomous navigation and control), and/or to the SV relevance apparatus 101 (e.g., for determining SV contextual relevance). In some example embodiments, the map database 112 can be downloaded, stored on, and/or accessed (e.g., via a wireless or wired connection) by UEs, SVs 105, and/or the SV relevance apparatus 101, for example.

In an example embodiment, the map data may include node data, road segment data or link data, point of interest (POI) data or the like. The database may also include cartographic data, routing data, and/or maneuvering data. According to some example embodiments, the road segment data records may be segments or segments representing roads, streets, or paths, as may be used in calculating a route or recorded route information for determination of one or more personalized routes. The map data may include various attributes of road segments and/or may be representative of sidewalks or other types of pedestrian segments, as well as open areas, such as grassy regions or plazas. The node data may be end points corresponding to the respective links and/or segments. The segment data and the node data may represent a road network, such as used by vehicles, cars, trucks, buses, motorcycles, and/or other entities. Optionally, the database may contain path segments and node data records or other data that may represent bicycle lanes, pedestrian paths or areas in addition to or instead of the vehicle road record data, for example.

The segment and nodes can be associated with attributes, such as geographic coordinates, street names, address ranges, speed limits, turn restrictions at intersections, direction of travel, and/or other navigation-related attributes, as well as POIs, such as fueling stations, hotels, restaurants, museums, stadiums, offices, auto repair shops, buildings, stores, parks, and/or the like. The database can include data about the POIs and their respective locations in the POI records. The database may include data about places, such as cities, towns, or other communities, and other geographic features such as bodies of water, mountain ranges, and/or the like. Such place or feature data can be part of the POI data or can be associated with POIs or POI data records (such as a data point used for displaying or representing a position of a city).

In addition, the map database 112 can include event data (e.g., traffic incidents, construction activities, scheduled events, unscheduled events, etc.) associated with the POI data records or other records of the map database. The map database 112 may further indicate a plurality of contiguous segments as a strand. Accordingly, resultant data may be generated that is associated with a strand, or a plurality of contiguous segments.

As illustrated in FIG. 1, the system architecture may include one or more environmental systems 120, or systems that may manage and provide data relating to an environment or context within which the SVs 105 operate and within which the user and a destination may be located. In various examples, the environmental systems 120 may be associated with and operated by entities different than an entity associated with the SV relevance apparatus 101 (e.g., a user with a UE) and/or entities associated with the SVs 105. Notwithstanding, the environmental systems 120 may be configured to provide data to the SV relevance apparatus 101 via the network 102. In various embodiments, the environmental systems 120 may include externally-facing application programming interfaces (APIs) configured to provide data to various interested parties, such as the SV relevance apparatus 101. Thus, in various embodiments, the SV relevance apparatus 101 is configured to generate and transmit API queries, calls, requests, and/or the like to one or more environmental systems 120 and to receive API responses from the one or more environmental systems 120 including data that may be used to generate contextual relevance measures for the SVs 105.

In the illustrated embodiment, examples of the environmental systems 120 include a weather forecasting system 122, which may manage and provide weather data to the SV relevance apparatus 101. In particular, the weather forecasting system 122 may generate, manage, update, provide, and/or the like data describing an ambient temperature for a geographical region, a precipitation, a humidity, wind conditions, weather/storm conditions, and/or the like. Such weather data may then be provided (e.g., in response to an API query) to the SV relevance apparatus 101. In various embodiments, the weather forecasting system 122 may communicate with a map services system 110 to obtain map data, such that the weather data can be matched with map data, overlaid the map data, categorized or organized according to geographic regions defined in the map data, and/or the like.

As also illustrated in FIG. 1, examples of the environmental systems 120 include a public transportation scheduling system 124, which may manage and provide scheduling data to the SV relevance apparatus 101. For example, the scheduling data may include data that describes a scheduled, routine, and/or estimated time of arrival for a public transportation mode, such as a bus, a train, or a subway. In various examples, the public transportation scheduling system 124 is configured to detect, determine, and/or receive indication of anomalous events that may impact the arrival times of public transportation mode. For instance, an entity associated with the public transportation scheduling system 124 may specify the occurrence of a maintenance event rendering a public transportation mode, an inadvertent or unanticipated delay, traffic conditions, collisions, accidents, and/or the like. Accordingly, such data and/or scheduling data generated and/or updated in response to such data can be provided to the SV relevance apparatus 101. In various embodiments, the system architecture may include multiple public transportation scheduling systems each associated with a public transportation mode. For instance, the SV relevance apparatus 101 may communicate with a first public transportation scheduling system associated with a bus line as well as a second public transportation scheduling system associated with a subway system.

Thus, the system architecture illustrated in FIG. 1 depicts various components that enable an SV relevance apparatus 101 to generate a contextual relevance measure for each of one or more SVs 105 and to cause contextually-relevant SVs to be indicated to a user seeking transportation. While FIG. 1 illustrates a map services system 110 and environmental systems 120 including a weather forecasting system 122 and a public transportation scheduling system 124, it will be understood that various other systems may be involved in the system architecture as the SV relevance apparatus 101 performs operations for determining and conveying SV contextual relevancies and that not all illustrated components may be required or used in various examples.

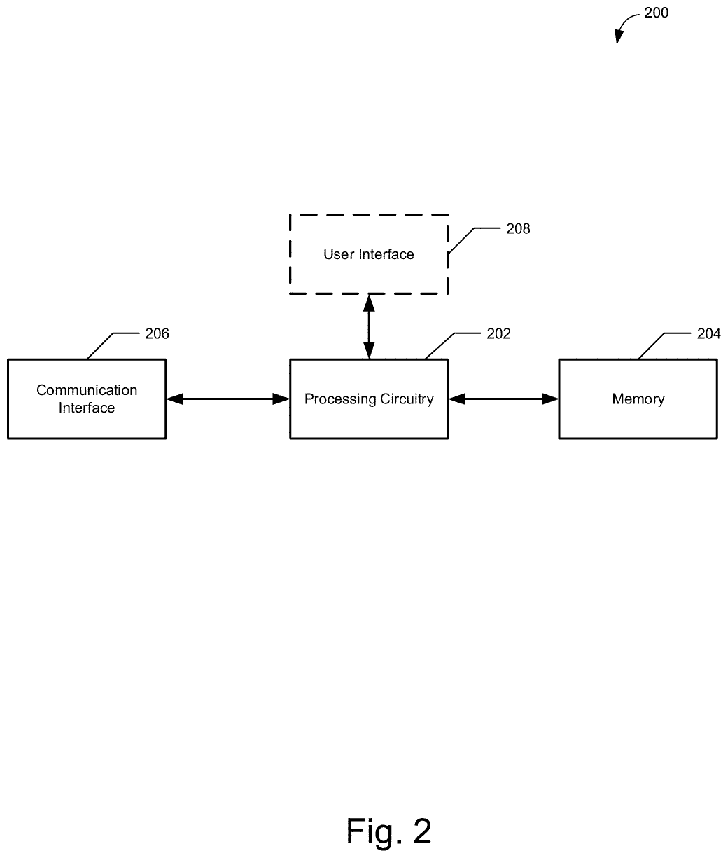

Referring now to FIG. 2, an apparatus 200 is provided in accordance with an example embodiment, for implementing the SV relevance apparatus 101. As discussed, the apparatus 200 may be a computing system or platform responsible for overseeing a plurality of SVs, a UE associated with a user seeking transportation, and/or the like. For example, the apparatus 200 is embodied by a wide variety of different computing devices including, for example, a server, a computer workstation, a personal computer, a desktop computer or any of a wide variety of computing devices. The apparatus 200 may include multiple computing devices that are configured to perform various operations and functionality, such as in a cloud computing architecture, a distributed computing architecture, an edge computing architecture, a fog computing architecture, and/or the like. As further examples, the apparatus 200 may be embodied by a variety of computing devices including, but not limited to, mobile devices, in-vehicle navigation systems, other navigation systems, in-vehicle infotainment systems, dynamic road signs, personal computers, and/or the like.

As also discussed, the SV relevance apparatus 101 may be embodied by an individual SV, an SV with leadership responsibility over other SVs, and/or the like. Accordingly, the apparatus 200 may be a computing device installed in-vehicle and/or on-board of an SV 105. In such example embodiments, the apparatus 200 may be in communication with other various components and modules of the SV 105, including illuminating hardware, motors and/or engines, transmission, audio playback hardware and/or a horn, and/or the like.

As illustrated in FIG. 2 then, the apparatus 200 of an example embodiment includes processing circuitry 202, memory 204 and communication interface 206. A user interface 208 may be included in apparatus 200 in some example embodiments, such as when the apparatus 200 is embodied by UE, and may generally be optional. In various embodiments, the illustrated components of the apparatus 200 are configured to cause the apparatus 200 to perform various operations for generating contextual relevance measures for SVs 105 and for causing contextually-relevant SVs to be indicated to a user.

In some embodiments, the processing circuitry 202 (and/or co-processors or any other processors assisting or otherwise associated with the processing circuitry) may be in communication with the memory device 204 via a bus for passing information among components of the apparatus. The memory device may be non-transitory and may include, for example, one or more volatile and/or non-volatile memories. In other words, for example, the memory device may be an electronic storage device (for example, a computer readable storage medium) comprising gates configured to store data (for example, bits) that may be retrievable by a machine (for example, a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processing circuitry.

The processing circuitry 202 may be embodied in a variety of different ways. For example, the processing circuitry may be embodied as one or more of various hardware processing means such as a processor, a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry may include one or more processing cores configured to perform independently. A multi-core processor may enable multiprocessing within a single physical package. Additionally or alternatively, the processing circuitry may include one or more processors configured in tandem via the bus to enable independent execution of instructions, pipelining and/or multithreading.

In an example embodiment, the processing circuitry 202 may be configured to execute instructions stored in the memory device 204 or otherwise accessible to the processing circuitry. Alternatively or additionally, the processing circuitry 202 may be configured to execute hard coded functionality. As such, whether configured by hardware or software methods, or by a combination thereof, the processing circuitry may represent an entity (for example, physically embodied in circuitry) capable of performing operations according to an embodiment of the present invention while configured accordingly. Thus, for example, when the processing circuitry is embodied as an ASIC, FPGA or the like, the processing circuitry may be specifically configured hardware for conducting the operations described herein. Alternatively, as another example, when the processing circuitry is embodied as an executor of software instructions, the instructions may specifically configure the processing circuitry to perform the algorithms and/or operations described herein when the instructions are executed. However, in some cases, the processing circuitry may be a processor of a specific device (for example, a computing device) configured to employ an embodiment of the present invention by further configuration of the processor by instructions for performing the algorithms and/or operations described herein. The processing circuitry 202 may include, among other things, a clock, an arithmetic logic unit (ALU) and logic gates configured to support operation of the processing circuitry 202.

The apparatus 200 of an example embodiment may also optionally include a communication interface 206 that may be any means such as a device or circuitry embodied in either hardware or a combination of hardware and software that is configured to receive and/or transmit data from/to other electronic devices in communication with the apparatus, such as any of the components of FIG. 1. Additionally or alternatively, the communication interface may be configured to communicate in accordance with various wireless protocols including Global System for Mobile Communications (GSM), such as but not limited to Long Term Evolution (LTE) and/or new radio (e.g., 5G). In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In this regard, the communications interface 206 may facilitate the collection of, and/or access to, probe data, and access to map data. In various embodiments, the communications interface 206 may comprise an input/output interface enabling the apparatus 200 to communicate with various sensors, devices, motors, actuators, power supplies, and/or the like, such as when the apparatus 200 is an in-vehicle or an on-board computing device for an SV 105.

The apparatus 200 of an example embodiment, such as a UE for a user seeking transportation, may also optionally include a user interface 208 that provides an audible, visual, mechanical, or other output to the user. As such, the user interface 208 may include, for example, a keyboard, a mouse, a display, a touch screen display, a microphone, a speaker, and/or other input/output mechanisms. As such, in embodiments in which apparatus 200 is implemented as user equipment, the user interface 208 may, in some example embodiments, provide means for indicating and identifying particular SVs that have been determined to be contextually relevant and, in some examples, provide instructions (e.g., navigation) to such particular SVs from a location of the user.

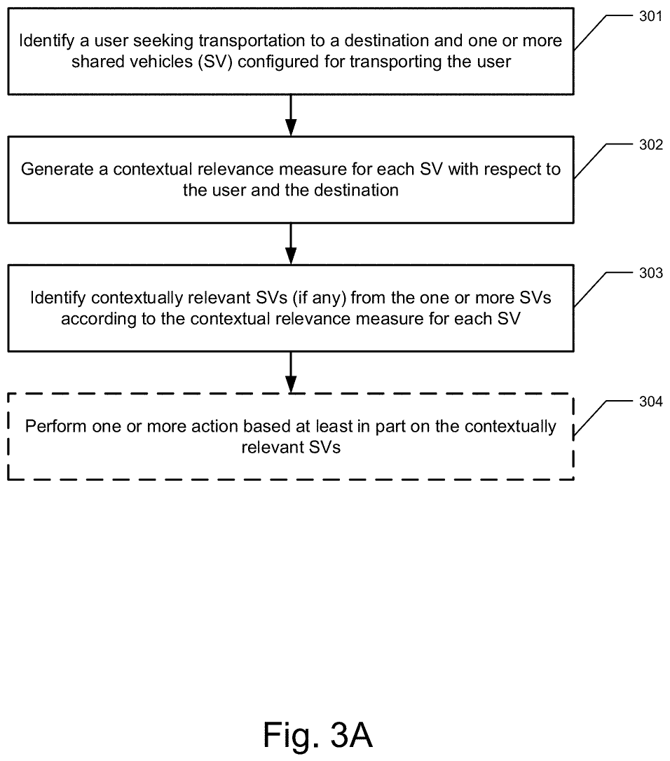

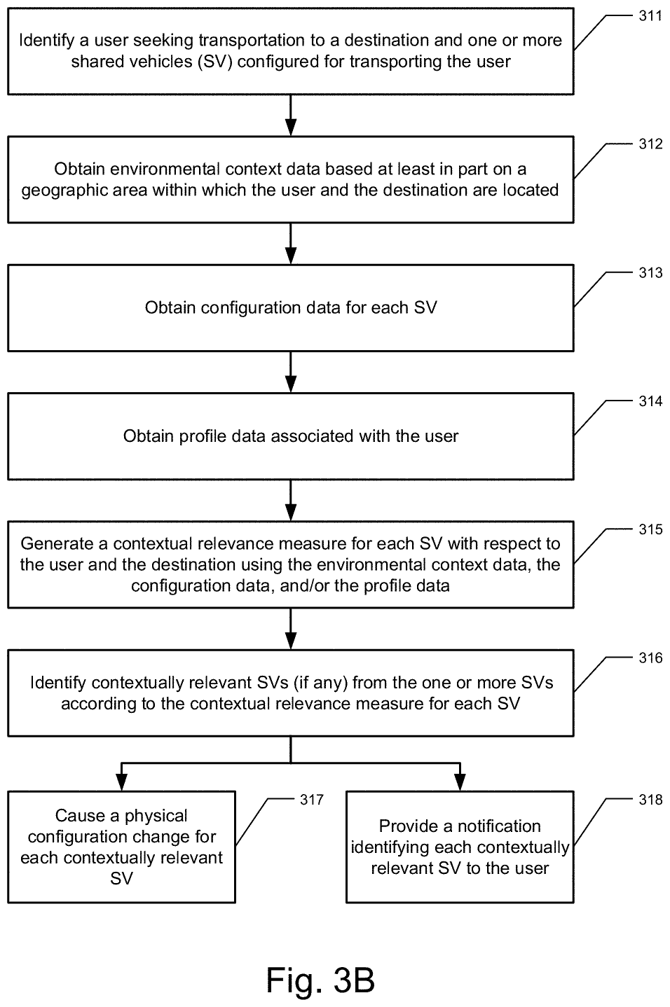

FIG. 3A is a flowchart illustrating example operations that may be performed by an apparatus 200, according to example embodiments. The operations of FIG. 3A may be performed by the apparatus 200 embodying the SV relevance apparatus 101, and the example operations are directed to determining and conveying contextual relevancies of SVs 105. Accordingly, example operations illustrated in FIG. 3, when performed by the apparatus 200, enable improved transportation efficiency of users and/or populations of users, among other example technical improvements.

As shown in operation 301, apparatus 200 includes means, such as processing circuitry 202, memory 204, communication interface 206, and/or the like, for identifying a user seeking transportation to a destination and one or more SVs 105 configured for transporting the user. In various embodiments, the user is identified based at least in part on a user request received by the apparatus 200, for example, from a UE associated with the user. The user request may specify the destination requested by the user, such as via geospatial coordinates, a name of an entity located at the destination, and/or the like. In various embodiments, identifying the user comprises locating, accessing, and/or retrieving profile data associated with the user.

In various embodiments, identifying the user comprises generating and/or receiving a location estimate for the user. The location estimate for the user may be used to identify the one or more SVs 105. For example, in one or more example embodiments, SVs 105 that are within a certain radius or distance from the location estimate for the user are identified. Each SV 105 may be associated with a unique identifier, and the one or more SVs 105 may be identified with respect to their respective unique identifiers.

As shown in operation 302, apparatus 200 includes means, such as processing circuitry 202, memory 204, and/or the like, for generating a contextual relevance measure for each SV 105 with respect to the user and the destination. The contextual relevance measure serves as a multi-dimensional description of whether the SV 105 is suitable and advantageous for transporting the user within the present context. As discussed, generally, the contextual relevance measure is generated based at least in part on data that describes status of public transportation modes and other alternative transportation modes, data associated with the user, data that describes the present context with respect to weather conditions, data associated with the SV 105, and/or any combination of the such. In various embodiments, the contextual relevance measure may be a scalar index that is generated and associated with each SV 105. In various embodiments, the contextual relevance measure may be generated using one or more machine learning models trained to recognize the present context and to estimate the relevance of each SV 105 in the present context.

As shown in operation 303, apparatus 200 includes means, such as processing circuitry 202, memory 204, and/or the like, for identifying contextually relevant SVs from the one or more SVs 105 according to the contextual relevance measure for each SV 105. In various embodiments, the contextually relevant SVs may be identified from the one or more SVs 105 based at least in part on ranking the one or more SVs 105 according to the contextual relevance measures. In other example embodiments, contextually relevant SVs may be identified based at least in part on comparing the contextual relevance measures against a configurable threshold value, whereupon SVs having contextual relevance measures that satisfy the configurable threshold value are deemed as contextually relevant.

As shown in operation 304, apparatus 200 includes means, such as processing circuitry 202, memory 204, and/or the like, for performing one or more actions based at least in part on the contextually relevant SVs. In various embodiments, the one or more actions may be performed optionally. Generally, the SVs 105 that are identified as contextually relevant are so indicated to the user, in some example embodiments. In various embodiments, a physical configuration change for the contextually relevant SVs and/or associated hardware (e.g., a docking station, a charging station, a fueling station, a storage station) is caused to prepare the contextually relevant SVs for potential user transportation, to attract the attention of the user, and/or the like. In various embodiments, the apparatus 200 is configured to remotely cause physical configuration changes for the contextually relevant SVs and/or their associated hardware. In various embodiments, the one or more actions may comprise generating and transmitting a report configured to describe the contextually relevant SVs and associated data (e.g., navigation data or instructions from the user's location to the contextually relevant SVs) to a UE associated with the user. The report may be used to configure a user interface providing a map interface for the user, such that the user may easily ascertain the location of the contextually relevant SVs.

FIG. 3B is a flowchart illustrating example operations of an apparatus 200, according to example embodiments. The operations of FIG. 3B may be performed by the apparatus 200 embodying the SV relevance apparatus 101, and the example operations are directed to determining and conveying contextual relevancies of SVs 105. Accordingly, example operations illustrated in FIG. 3, when performed by the apparatus 200, enable improved transportation efficiency of users and/or populations of users, among other example technical improvements.

As shown in operation 311, apparatus 200 includes means, such as processing circuitry 202, memory 204, communication interface 206, and/or the like, for identifying a user seeking transportation to a destination and identifying one or more SVs 105 configured for transporting the user, or generally for user transportation. In various embodiments, the apparatus 200 may receive, via communication interface 206, a user request for efficient transportation to a specified destination, and the user request may be configured to identify the user to be transported. For instance, the user request may include an account user name, an identifier token, a name, and/or the like. In some instances, an example user request may be overt with regard to shared mobility, with the user request conveying that the user would consciously desire to use an SV 105 or at least an alternative to another transportation mode. In some other instances, an example user request may simply convey a desire of the user to reach a specified destination, and through the example operations of FIG. 3, the apparatus 200 may indicate to the user that SV-based transportation is the most relevant or advantageous transportation mode to reach the specified destination, in some examples. Accordingly, in some example embodiments, apparatus 200 may be incorporated, implemented within, and/or in communication with a navigation system, such that navigation guidance provided to the user may additionally specify contextual relevance of SVs 105.

Alternatively, in example embodiments, the apparatus 200 is configured to select and identify users agnostic to user requests or user initiation and according to overarching transportation objectives, for example. As a non-limiting illustrative example, the apparatus 200 may monitor population densities at points of interest, such as transportation hubs, and in order to distribute users across transportation modes for efficient population transportation, the apparatus 200 may be configured to select and identify a subset of the users for consideration for SV-based transportation. Accordingly, in some example embodiments, the apparatus 200 is configured to identify one or more users located at a point of interest upon determining that a capacity or threshold number of users are located at the point of interest, for example.

Identification of the user further comprises determining a location of the user, which can enable identification of SVs 105 and generation of contextual relevance measures for the SVs 105. In various embodiments, one or more users are identified via associated UEs, which are configured to determine their respective locations (e.g., using global navigation satellite systems, using global positioning systems). Thus, a location of the user, or specifically a position estimate for the user, is provided to the apparatus 200.

In various embodiments, the apparatus 200 identifies a plurality of SVs 105 configured to transport the user, and in some examples, identification of the SVs 105 may be based at least in part on a resting position or location of SVs 105 that are not presently or actively being operated. For example, the apparatus 200 may identify SVs 105 that are positioned (and not presently being operated) within a radius of the user's location, within a geographic area or sector within which the user is located, and/or the like.

In operation 312, apparatus 200 may include means, such as processing circuitry 202, memory 204, communication interface 206, and/or the like, for obtaining environmental context data based at least in part on a geographic area within which the user and a destination for the user are located. As discussed, in various embodiments, environmental context data may be used to generate a contextual relevance measure for each SV 105 identified in operation 311. Generally, environmental context data may refer to data describing an environment or context with respect to certain aspects not necessarily associated with the identified user and SVs 105. In various embodiments, environmental context data may include scheduling data for one or more transportation modes alternative to SV-based transportation or shared mobility and/or weather data (e.g., ambient temperature, precipitation, humidity, wind condition, storm conditions). For example, the scheduling data may describe scheduled times of arrival and estimated times of arrivals (which may be delayed) for a public transportation mode such as a bus, train, a subway, and/or the like.

In various examples, environmental context data is stored and managed by environmental systems that may be external, separate, and/or associated with entities different than the apparatus 200. Accordingly, obtaining environmental context data may comprise generating and transmitting an API query, call, request, and/or the like to at least one environmental system 120 and receiving an API response comprising environmental context data from the environmental system 120. In some example embodiments, the environmental systems 120 may publish the environmental context data (e.g., scheduling data, weather data), and the apparatus 200 is configured to retrieve and process the published environmental context data.

In operation 313, apparatus 200 includes means, such as processing circuitry 202, memory 204, communication interface 206, and/or the like, for obtaining configuration data for each SV 105. In contrast to environmental context data which may not be necessarily specific to the user and the SVs 105, configuration data describes aspects, characteristics, properties, capabilities, specifications, and/or the like for each SV 105, in various embodiments. Configuration data may include static configuration data for a SV 105, such as a vehicle type, a number of users that it may transport, an operation zone or boundary, and/or the like, and configuration data may additionally or alternatively include dynamic configuration data for a SV 105, such as a power or fuel level, an operation range, trip and/or traveled distance, and/or the like. In various embodiments, an SV 105 may be configured with an operation zone or boundary within which the SV 105 may be used for transportation and outside of which use of the SV 105 may be limited. Through obtaining configuration data for an SV 105, the apparatus 200 may obtain a knowledge of the capability of the SV 105 in transporting the user.

In operation 314, apparatus 200 includes means, such as processing circuitry 202, memory 204, communication interface 206, and/or the like, for obtaining profile data associated with the user. The identified user may be associated with profile data that generally describes historical behavior of the user, characteristics and/or demographics of the user, and/or the like. In various embodiments, the profile data may describe a historically preferred transportation mode or a frequently taken transportation mode for the user, and in various embodiments, SV contextual relevance may be determined with respect to or in comparison to the historically preferred or frequently taken transportation mode. Similarly, the profile data for the user may identify subscriptions, memberships, passes, pre-paid cards, and/or the like owned by the user for public transportation use. In various embodiments, the profile data may include demographic data and/or other data that may be indicative of the user's capabilities and preference for some shared vehicle types. For instance, the profile data for the user may include a user age, which may be later used to predict the user's disposition towards shared vehicle types such as scooters or bicycles. In some examples, the profile data may further describe the user's inclination towards certain weather conditions, which may serve as a prediction factor for whether a user would be willing to use an exposed shared vehicle (e.g., a shared scooter, a shared bicycle) in the certain weather conditions.

In operation 315, apparatus 200 includes means, such as processing circuitry 202, memory 204, and/or the like, for generating a contextual relevance measure for each SV 105 with respect to the user and the destination. In various embodiments, the contextual relevance measure is generated using at least one of the environmental context data, the configuration data, and/or the profile data. In various embodiments, the contextual relevance measure for an SV 105 may be data entity configured to describe the contextual relevance of the SV 105, or a degree of availability, advantages, reliability, efficiency, and/or the like provided by the SV 105 over its alternatives (e.g., other transportation modes, other SVs 105). Through using environmental context data, configuration data, and/or the profile data, the contextual relevance measure can be generated while considering multiple dimensions and aspects of the transportation context.

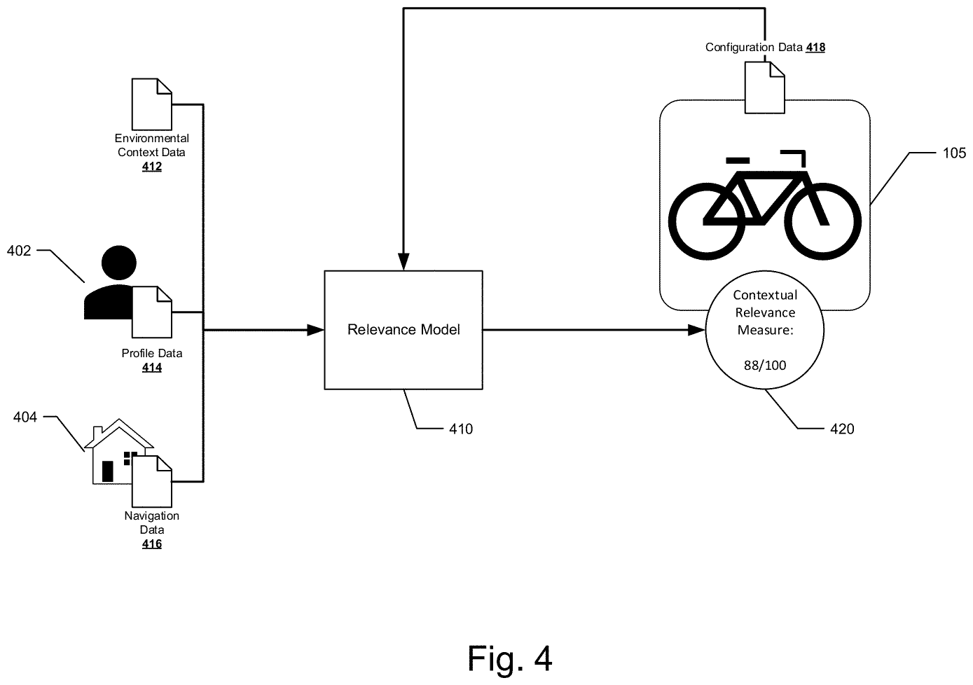

FIG. 4 provides a diagram depicting operation 315 for generating a contextual relevance measure for an SV 105. As illustrated in FIG. 4, a relevance model 410 may be used to generate the contextual relevance measure 420 for a shared vehicle 105. Generally, in various embodiments, the relevance model 410 receives input data and processes the input data to generate and output the contextual relevance measure 420. In accordance with various embodiments described herein, the input data for the relevance model 410 includes the environmental context data 412, profile data 414 associated with a user 402, navigation data 416 associated with a destination, and/or configuration data 418 associated with the SV 105 for which the contextual relevance measure 420 is being generated.

In various embodiments, the environmental context data 412, which includes scheduling data for alternative transportation modes, as well as the navigation data 416 that describes navigation paths and routes to the destination 404 are used by the relevance model 410 to compare the alternative transportation modes and the SV 105. For example, the relevance model 410 is configured to, using the environmental context data 412 and the navigation data 416, determine an estimated travel time or duration, an estimated delay duration, an estimated time of arrival, an estimated departure time, and estimated cost, and/or the like for an alternative transportation mode, and likewise determine the same for the SV 105 (e.g., using the configuration data 418 for the SV 105), thereby enabling the comparison. The alternative transportation modes selected for comparison against the SV 105 may include historically preferred and frequently used transportation modes as described by the profile data 414.

In various embodiments, the relevance model 410 is configured to generate estimates and predictions relating to alternative transportation modes, the SV 105, the user's preference between the alternative transportation modes and the SV 105, and/or the like by being trained via machine learning. That is, the relevance model 410 may comprise one or more machine learning models that may include machine learning models configured to output estimated times of arrival, machine learning models configured to output estimated delay durations, machine learning models configured to predict user's choices between transportation modes, and/or the like. Such machine learning models may be trained using supervised and/or semi-supervised learning given historical labelled data that describes historical choices may be users between transportation modes, historical labelled data that describes historical durations of delays, and/or the like. For example, the profile data 414 for the user 402 may be used as training data for the relevance model 410. In some example embodiments, the relevance model 410 comprises a deep neural network machine learning model configured to receive at least the environmental context data 412 and generate a reduced-dimension and/or scalar output that is the contextual relevance measure 420. In the illustrated embodiment, for example, the contextual relevance measure 420 is an index value (88/100) that may be scaled to describe contextual relevance as a percentage.

Thus, in various embodiments, the relevance model 410 is configured to generate the contextual relevance measure 420 for the SV 105 with respect at least to a context of different transportation modes given at least the environmental context data 412. As previously discussed, the environmental context data 412 may include weather data, which can provide yet another context that can be captured in the contextual relevance measure 420.

While example embodiments described herein involve generating a contextual relevance measure 420 for each SV 105, various other example embodiments may involve generating a contextual relevance measure 420 for shared mobility generally compared to other transportation modes. That is, in such embodiments, generation of one overall contextual relevance measure for SV-based transportation may not be concerned with individual SVs, and configuration data 418 for multiple SVs may be used. The overall contextual relevance measure for SV-based transportation may then describe overall relevance of shared mobility (e.g., over alternative transportation modes), rather than contextual relevancies of specific SV units (e.g., over each other and over the alternative transportation modes). Thus, an overall contextual relevance measure for shared mobility generally may be conveyed to a user to suggest the use of SVs 105 to the user without specifically identifying certain SVs to use.

Returning to FIG. 3, in operation 316, apparatus 200 includes means, such as processing circuitry 202, memory 204, and/or the like, for identifying contextually relevant SVs from the one or more SVs 105 according to the contextual relevance measure for each SV 105. In some example instances, there may be no SVs identified as contextually relevant. Otherwise, at least a subset of the one or more SVs 105 may be identified as contextually relevant. In various embodiments, SVs 105 may be ranked according to the contextual relevance measures 420 for each SV 105. In such embodiments, a configurable percentage or a configurable number of SVs 105 may be selected according to the ranking, with the selected SVs being the most contextually relevant SVs. In other embodiments, the contextual relevance measures 420 for each SV 105 may be evaluated against a configurable threshold, and any SV 105 having a contextual relevance measure 420 satisfying the configurable threshold may be deemed to be contextually relevant.

With contextually relevant SVs being identified, the contextually relevant SVs are indicated to the user. In various embodiments, one or both of operations 317 and 318 may be performed to indicate contextually relevant SVs to the user. In operation 317, apparatus 200 includes means, such as processing circuitry 202, memory 204, communication interface 206, and/or the like, for causing a physical configuration change for each contextually relevant SV. From an initial position or while moving, a contextually relevant SV is caused to undergo a physical configuration change such that the contextually relevant SV is visibly distinguished from its earlier state and from other SVs that are not contextually relevant.

In various embodiments, the contextually relevant SVs may be indicated within a report that is generated, prepared, stored, and/or transmitted to one or more UEs. The report may generally be configured to identify the contextually relevant SVs and to describe various information that may have caused the SVs to be identified as contextually relevant and/or that may be used to initialize and enable user transportation via the contextually relevant SVs. For example, in some example embodiments, the report includes a unique identifier for each contextually relevant SV, a location estimate (e.g., geospatial coordinates) of each contextually relevant SV, map and/or layer data associated with each contextually relevant SV (e.g., operation zones), the configuration data of each contextually relevant SV (e.g., power or fuel levels, passenger capacity), and/or the like. For example, in some example embodiments, the report includes customized and/or individualized instructions for initializing transportation with a contextually relevant SV, which may include navigational instructions and/or operational instructions. Upon preparation and generation of the report, the report may be stored in memory for later access and usage, such as to train one or more machine learning models or to enable SV fleet-wide analytics. In some example embodiments, the report may be in a standardized format and can be transmitted (e.g., via an API) to one or more requesting devices (e.g., a UE).

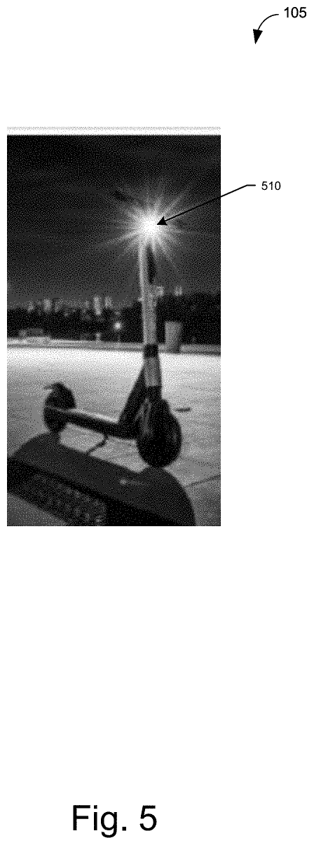

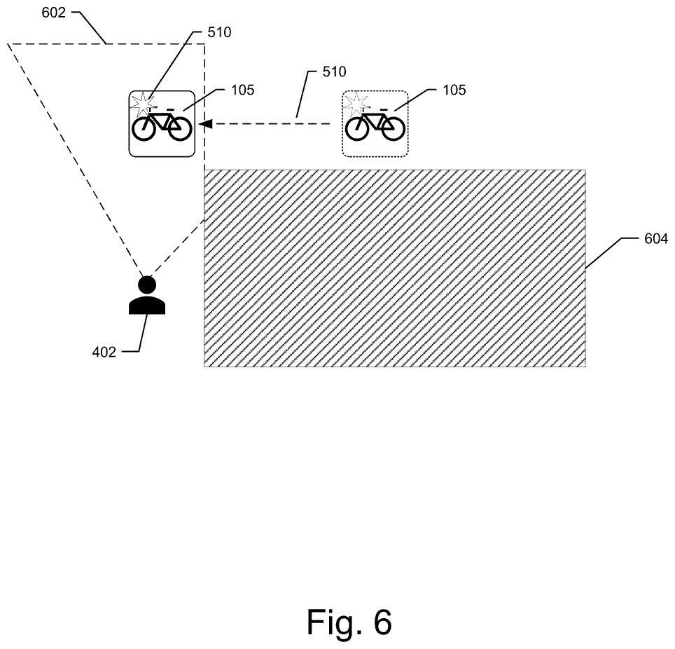

Each of FIG. 5 and FIG. 6 depict example embodiments of operation 317 in which a physical configuration change is caused for a contextually relevant SV. In FIG. 5, the physical configuration change 510 for the SV 105 that is identified as contextually relevant is the operation of illuminating hardware, or toggling on of a headlight for example. With this physical configuration change 510, a user can quickly and easily understand the SV 105 as being contextually relevant for transportation to a destination. Further examples of operating illuminating hardware may include strobing the headlight, configuring the headlight with a specific color associated with contextual relevance, flashing a light pattern with a pre-determined frequency, rhythm, and/or color, and/or the like.

Although not explicitly illustrated, a physical configuration change 510 may include audio aspects. Some example shared vehicles may include horns, speakers, or audio generation devices that can be operated to indicate contextual relevance. SVs 105 identified as contextually relevant may be caused to play a chime, tune, sound, siren, and/or the like to attract a user's attention.

In FIG. 6, the physical configuration change 510 includes causing movement of the SV 105 identified as being contextually relevant, and in various embodiments, the movement comprises movement of the SV 105 into a line-of-sight 602 of the user 402. As illustrated, an obstruction 604 may be positioned between the contextually-relevant SV and the user 402, and as a result, operation of illuminating hardware may not appropriately capture the user's attention. Accordingly, SV 105 may be configured to move from an initial position, and the apparatus 200 may be configured to cause the SV 105 to move from its location into a line-of-sight 602 of the user 402. In doing so, the apparatus 200 may map the line-of-sight 602 of the user 402 based at least in part on location and orientation data associated with the user 402. Further, the apparatus 200 may use three-dimensional geometric map data (e.g., provided by the map services system 110) to map a line-of-sight 602 for the user, such that a navigation path from the SV 105 to the line-of-sight 602 can be determined.

In various embodiments, a physical configuration change can be caused for any hardware associated with a contextually relevant SV. For instance, a contextually relevant SV may be docked at a charging station, a fueling station, a storage station, a docking station, and/or the like. Accordingly, a physical configuration change may be caused for said charging station, storage station, docking station, and/or the like. The physical configuration change may generally prepare the contextually relevant SV and the associated hardware for potential user transportation, with the contextually relevant SV being indicated to the user. In some example embodiments, the associated hardware may undergo a physical configuration change to charge or fuel the contextually relevant SV to at least a threshold amount of power or fuel based at least in part on the specified destination for the user. In some example embodiments, the associated hardware may undergo a physical configuration change to release (e.g., unlock, undock) the contextually relevant SV for use by the user; and in one or more example embodiments, the associated hardware releases the contextually relevant SV based at least in part on the location of the user. For example, the associated hardware is caused to release the contextually relevant SV once the user is within a threshold distance of the associated hardware (e.g., a storage or docking station). In various embodiments, the physical configuration change for the associated hardware may similarly include operation of illuminating hardware; for example, a docking station may include a large light fixture, a large screen or billboard, and/or the like that may be well-suited to attract the attention of the user.

Returning to FIG. 3, in operation 318, apparatus 200 includes means, such as processing circuitry 202, memory 204, communication interface 206, and/or the like, for providing a notification identifying each contextually relevant SV to the user. In various embodiments, the notification identifying each contextually relevant SV may be a push notification, a text message, an automated call, an e-mail, and/or the like provided via UE associated with the user.

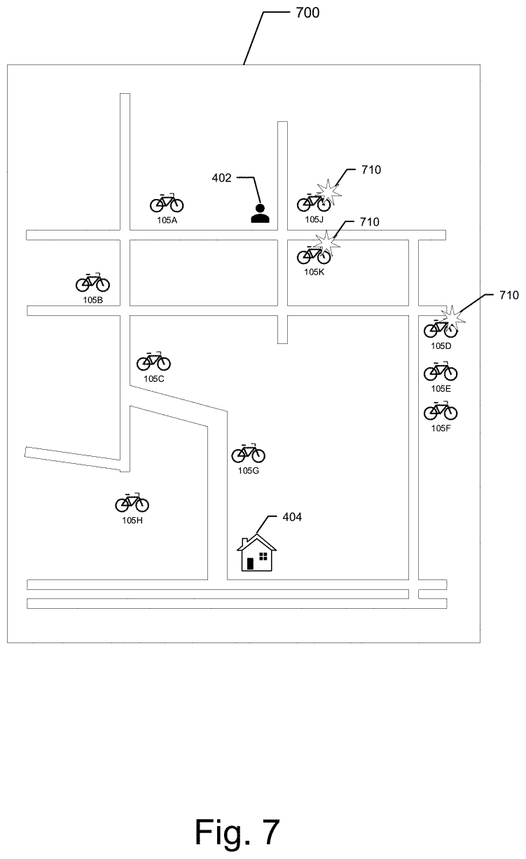

In various embodiments, the notification is provided via a user interface. In such example embodiments, the notification may be provided via a map (e.g., a digital map) rendered for display via the user interface, or may be configured to direct the user to the map responsive to user interaction. FIG. 7 illustrates an example user interface 700 through which contextually relevant SVs may be identified to the user. As illustrated in FIG. 7, the user interface 700 illustrates a map of the geographical region within which the user 402 is located, and the map may be provided by the map services system 110 and/or generated using map data obtained from the map services system 110. In the illustrated embodiment, the map depicts streets and roads extending through the geographical region within which the user 402 is located, and the user interface 700 further indicates the location of the user 402. In some example embodiments in which the user 402 has specified a destination 404, the user interface 700 further indicates the location of the destination 404.

As illustrated in FIG. 7, the user interface 700 is configured to indicate locations of SVs 105 that may be configured for transportation for the user, located within a threshold distance of the user, equipped with adequate power and/or fuel levels for transporting the user to the destination 404, and/or the like. Accordingly, with the user interface 700, the user 402 may be made aware of the availability and locations of SVs 105. In the illustrated embodiment, the user interface 700 further indicates the SVs 105 identified as being contextually relevant. In various embodiments, the contextually relevant SVs 105 may be caused to undergo physical configuration changes 510 to attract the user's attention in the real world, and the user interface 700 may additionally or alternatively provide virtual configuration changes to indicate the contextually relevant SVs to the user via the user's UE. For example, similar to the operation of illuminating hardware for a physical configuration change 510, symbols representing the contextually relevant SVs in the user interface 700 may flash, strobe, change color, and/or the like. Audio indications may additionally be provided via the user's UE. With the indications provided via the user interface 700, contextual relevance of shared mobility and/or of each SV 105 can be indicated to the user 402, such that the user 402 may be inspired to use shared mobility (over alternative transportation modes) to reach a destination 404.

In various embodiments, the example operations of FIG. 3B may be performed repeatedly, continuously, at a frequency, and/or the like, such that contextual relevancy of SVs 105 is determined and conveyed in real-time. With efficiency of user transportation being of interest, the contextual relevancy of shared mobility and SVs 105 may dynamically change according to the context, such as the status of alternative transportation modes. Thus, in various embodiments, the apparatus 200 is configured to generate the contextual relevance measure over a time course when a user is seeking transportation. As non-limiting examples, a contextual relevance measure for a SV 105 may be generated every five seconds, every thirty seconds, every minute, every five minutes, every thirty minutes, every hour, and/or the like.

Accordingly, as described herein, various embodiments described herein address technical challenges through dynamically (e.g., over time) determining and conveying contextual relevancies of shared vehicles for transporting users to their destinations. Various embodiments of the present disclosure enable users to more efficiently travel to their destinations through the promoted usage of shared vehicles in advantageous contexts. In an aforementioned example, shared vehicles may be promoted to users when a public transportation mode is delayed, thereby enabling users to reach their destinations without being significantly impacted by such delays. Various embodiments provide further technical effects, including improved (e.g., increased) throughput and reduced load of public transportation, as well as some environmental benefits. Example embodiments therefore provide improvements to the usage of shared vehicles, to the efficiency of shared mobility and SV-based transportation, to the throughput and operation of alternative transportation modes, and generally to the field of user transportation.

FIGS. 3A and 3B illustrate flowcharts depicting methods according to example embodiments of the present disclosure. It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 204 of an apparatus 200 employing an embodiment of the present invention and executed by the processing circuitry 202. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Furthermore, in some embodiments, additional optional operations may be included. Modifications, additions, or amplifications to the operations above may be performed in any order and in any combination.

Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An apparatus comprising at least processing circuitry and at least one non-transitory memory including computer program code instructions, the computer program code instructions configured to, when executed by the processing circuitry, cause the apparatus to:
identify a user seeking transportation to a destination and one or more shared vehicles configured for transporting the user;
obtain environmental context data based at least in part on a geographic area within which the user and the destination are located;
generate a contextual relevance measure for each shared vehicle of the one or more shared vehicles with respect to the user and the destination, wherein the contextual relevance measure is generated according to at least one of the environmental context data, configuration data for the one or more shared vehicles, or profile data associated with the user; and
responsive to determining that the contextual relevance measure for a particular shared vehicle of the one or more shared vehicle satisfies a configurable threshold, cause a physical configuration change for the particular shared vehicle.

2. The apparatus of claim 1, wherein the contextual relevance measure for each shared vehicle is dynamically generated over time, and wherein the physical configuration change is caused for a given time period.

3. The apparatus of claim 1, wherein the environmental context data comprises scheduling data of one or more alternative transportation modes.

4. The apparatus of claim 3, wherein the one or more alternative transportation modes comprises a public transportation mode historically used by the user according to the profile data associated with the user.

5. The apparatus of claim 1, wherein the environmental context data is obtained from one or more environmental systems via an application programming interface (API).

6. The apparatus of claim 1, wherein the computer program code instructions are configured to, when executed by the processing circuitry, cause the apparatus to cause the physical configuration change for the particular shared vehicle by:
determining whether the particular shared vehicle at an initial position is within a direct line-of-sight of the user; and
upon determination that the particular shared vehicle at the initial position is not within the direct line-of-sight of the user, causing movement of the particular shared vehicle to a visible position determined to be within the direct line-of-sight of the user.

7. The apparatus of claim 1, wherein the computer program code instructions are configured to, when executed by the processing circuitry, cause the apparatus to cause the physical configuration change for the particular shared vehicle by operating illuminating hardware of the particular shared vehicle.

8. The apparatus of claim 1, wherein the physical configuration change for the particular shared vehicle is caused remotely via network communication.

9. The apparatus of claim 1, wherein the contextual relevance measure is generated via a weighted combination of the environmental context data, the configuration data for the plurality of shared vehicles, and the profile data associated with the user.

10. A method comprising:
identifying a user seeking transportation to a destination and one or more shared vehicles configured for transporting the user;
obtaining environmental context data based at least in part on a geographic area within which the user and the destination are located;
generating a contextual relevance measure for each shared vehicle of the one or more shared vehicles with respect to the user and the destination, wherein the contextual relevance measure is generated according to at least one of the environmental context data, configuration data for the one or more shared vehicles, or profile data associated with the user; and
responsive to determining that the contextual relevance measure for a particular shared vehicle of the one or more shared vehicle satisfies a configurable threshold, causing a physical configuration change for the particular shared vehicle.

11. The method of claim 10, wherein the contextual relevance measure for each shared vehicle is dynamically generated over time, and wherein the physical configuration change is caused for a given time period.

12. The method of claim 10, wherein the environmental context data comprises scheduling data of one or more alternative transportation modes.

13. The method of claim 12, wherein the one or more alternative transportation modes comprises a public transportation mode historically used by the user according to the profile data associated with the user.

14. The method of claim 10, wherein the environmental context data is obtained from one or more environmental systems via an application programming interface (API).

15. The method of claim 10, wherein causing the physical configuration change for the particular shared vehicle comprises:
determining whether the particular shared vehicle at an initial position is within a direct line-of-sight of the user; and
upon determination that the particular shared vehicle at the initial position is not within the direct line-of-sight of the user, causing movement of the particular shared vehicle to a visible position determined to be within the direct line-of-sight of the user.

16. The method of claim 10, wherein causing the physical configuration change for the particular shared vehicle comprises operating illuminating hardware of the particular shared vehicle.

17. The apparatus of claim 1, wherein the physical configuration change for the particular shared vehicle is caused remotely via network communication.

18. The apparatus of claim 1, wherein the contextual relevance measure is generated via a weighted combination of the environmental context data, the configuration data for the plurality of shared vehicles, and the profile data associated with the user.

19. A computer program product comprising at least one non-transitory computer-readable storage medium having computer-executable program code instructions stored therein, the computer-executable program code instructions comprising program code instructions to:
identify a user seeking transportation to a destination and one or more shared vehicles configured for transporting the user;
obtain environmental context data based at least in part on a geographic area within which the user and the destination are located;
generate a contextual relevance measure for each shared vehicle of the one or more shared vehicles with respect to the user and the destination, wherein the contextual relevance measure is generated according to at least one of the environmental context data, configuration data for the one or more shared vehicles, or profile data associated with the user; and
responsive to determining that the contextual relevance measure for a particular shared vehicle of the one or more shared vehicle satisfies a configurable threshold, cause a physical configuration change for the particular shared vehicle.

20. The computer program product of claim 10, wherein the contextual relevance measure for each shared vehicle is dynamically generated over time, and wherein the physical configuration change is caused for a given time period.
